(19) United States
(12) Patent Application Publication
(10) Pub. No.: US 2025/0165310 A1
(43) Pub. Date: May 22, 2025

(54) LEAKAGE RESOURCE MANAGEMENT

(71) Applicant: Micron Technology, Inc., Boise, ID (US)

(72) Inventors: Leon Zlotnik, Camino, CA (US); Leonid Minz, Beer Sheva (IL)

(21) Appl. No.: 18/913,696

(22) Filed: Oct. 11, 2024

Related U.S. Application Data
(60) Provisional application No. 63/601,309, filed on Nov. 21, 2023.

(51) Int. Cl. G06F 9/50

(52) U.S. Cl. CPC G06F 9/5094; G06F 9/5016; G06F 9/5044

(57) ABSTRACT

Resource can be managed by accessing, at a resource manager of a system, a leakage-temperature table. The resource manager can determine a dynamic resource pool and a static resource pool of the system based on the leakage-temperature table. The resource manager can receive a resource request from a device of the system. The resource manager can assign resources to the device from the dynamic resource pool and the static resource pool.

### PRIORITY INFORMATION

This application claims the benefit of U.S. Provisional Application No. 63/601,309, filed on Nov. 21, 2023, the contents of which are incorporated herein by reference.

### TECHNICAL FIELD

Embodiments of the disclosure relate generally to leakage resource management, and more specifically, relate to managing resources by compensating for leakage.

### BACKGROUND

Various types of electronic devices such as digital logic circuits and memory systems may store and process data. A digital logic circuit is an electronic circuit that processes digital signals or binary information, which can take on two possible values (usually represented as 0 and 1). The digital logic circuit can use logic gates to manipulate and transform the digital signals or binary information. Digital logic circuits can be, for example, used in a wide range of electronic devices including computers, calculators, digital clocks, and many other electronic devices that employ digital processing. Digital logic circuits can be designed to perform specific logical operations on digital inputs to generate digital outputs, and, in some instances, can be combined to form more complex circuits to perform more complex operations. A memory device can include one or more memory devices that store data. The memory devices can be, for example, non-volatile memory devices and volatile memory devices. In general, a host system can utilize a memory system to store data at the memory devices and to retrieve data from the memory devices.

### BRIEF DESCRIPTION OF THE DRAWINGS

The present disclosure will be understood more fully from the detailed description given below and from the accompanying drawings of various embodiments of the disclosure.

FIG. 1 illustrates an example computing system that includes a memory sub-system in accordance with some embodiments of the present disclosure.

FIG. 2 illustrates an example of resource manager circuitry in accordance with some embodiments of the present disclosure.

FIG. 3 is a flow diagram corresponding to a method for leakage resource management in accordance with some embodiments of the present disclosure.

FIG. 4 is a block diagram of an example computer system in which embodiments of the present disclosure may operate.

### DETAILED DESCRIPTION

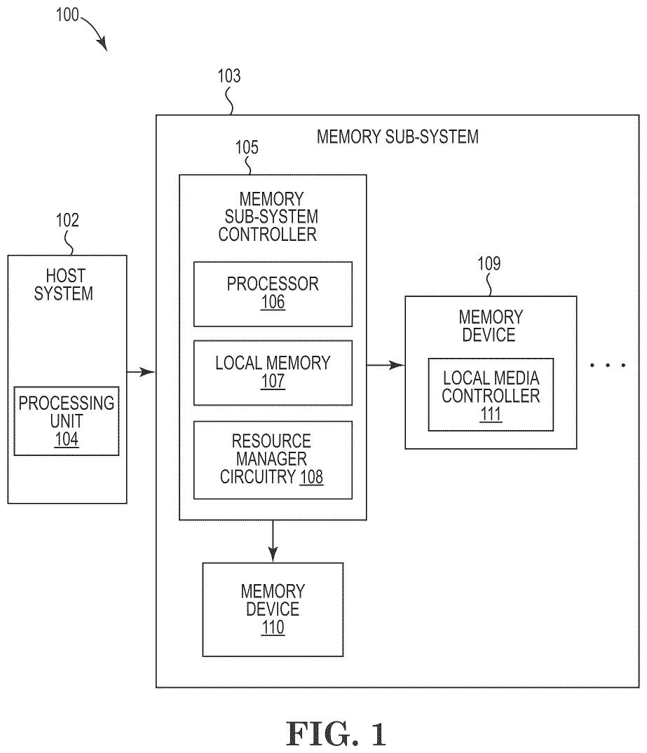

Aspects of the present disclosure are directed to leakage resource management. A resource manager of a system can access a leakage-temperature table. The resource manager can determine a dynamic resource pool and a static resource pool of the system based on the leakage-temperature table. Devices of the system can request resources from the system. The resource manager can assign the resources to the devices from the dynamic resource pool and the static resource pool. The dynamic resource pool and the static resource pool can, combined, form a total resource pool of the system. The dynamic resource pool can be comprised of dynamic resources while the static resource pool is comprised of static resources. The system can be a memory sub-system. The memory sub-system can be a storage system, storage device, a memory module, or a combination of such. An example of a memory sub-system is a storage system such as a solid-state drive (SSD). Examples of storage devices and memory modules are described below in conjunction with FIG. 1, et alibi. In general, a host system can utilize a memory sub-system that includes one or more components, such as memory devices that store data. The host system can provide data to be stored at the memory sub-system and can request data to be retrieved from the memory sub-system.

Although some non-limiting examples herein are generally described in terms of applicability to memory sub-systems and/or to memory devices, embodiments are not so limited, and aspects of the present disclosure can be applied as well to systems such as computer systems. The embodiments describe can be applicable to a system-on-a-chip, computing sub-system, data collection and processing, storage, networking, communication, power, artificial intelligence, control, telemetry, sensing and monitoring, digital entertainment and other types of systems/sub-systems and/or devices.

A system, such as a memory sub-system can provide system resources to devices of the system or devices external to the system. As used herein resources (e.g., system resources) can include power resources among other types of resources such as processing resources, for example. A device can request power from the system to perform operations. The device can utilize the power to, for example, write data, read data, transfer data via an input/output (I/O) bus, and/or transfer data via an interface that couples the system (e.g., memory sub-system) to a different system (e.g., host).

A number of attributes of the system can vary and may cause the resources provided to a device to be insufficient to perform the operations (e.g., read data, write data, perform logical operations, matrix operations, etc.). As a result, the system may have insufficient resources at least in some instances to satisfy the resource (e.g., power) demands of all devices. Thus, some devices may utilize more resources than a quantity of resources assigned to the devices.

For example, a device can request power resources from the system. The system can assign power resources to the device without the understanding that not all of the power resources assigned to the device are necessarily available at all instances to the device to perform operations due to leakage. A leakage can be dependent on an attribute of the system. An attribute of the system can be a temperature and/or a voltage of the system and/or the device, but can include other attributes of the system. The temperature and/or a voltage of the system can cause a current of the system to leak and/or an amount of leakage to vary. As used herein, leakage describes the unavailability of a resource for performing operations. The resources assigned to a device that are available to the device for performing operations are referred to as dynamic resources. Resources assigned to the device that are not available to the device for performing operations are referred to as static resources. A current leakage can be referred to as a static resource. The device can consume the target resources (e.g., a quantity of resources requested by the device) even though the assigned resources (e.g., a quantity of resources assigned to the device) s are less than the consumed resources because the system may not take into consideration the leakage variations due to temperature and/or voltage. The system may be unable to accurately calculate a leakage without using a temperature and/or voltage dependency. In various embodiments, the dynamic resource pool and the static resource pool can be calculated based on a temperature and/or a voltage of the system, which can cause the device to consume more resources than the assigned resources. Power may not be available to other devices due to the device consuming more resources than were assigned to the device.

A system can also provide more resources to the device than are requested by the device to compensate for the static resources. Without calculating the static resource pool, the system may provide more resources than are consumed by the device. The system may assume a worst-case scenario (e.g., without calculating the static resource pool) and may assign more resources than are needed to compensate for leakage. Providing more resources than are consumed by the device may cause resources to go unused which can limit the efficiency of the device and/or the system.

In order to address these and other deficiencies of current approaches, embodiments of the present disclosure allow for the calculation of dynamic resources (e.g., a dynamic resource pool) and static resources (e.g., a static resource pool) based on a temperature and/or a voltage. Calculating the dynamic resource pool and the static resource pool can allow the system to assign the appropriate dynamic resources and static resources to a device. Assigning the appropriate dynamic resources to a device can allow the device to utilize the assigned dynamic resources and not utilize more resources than are assigned or less resources than are assigned. A device that does not utilize more resources than are assigned or less resources than are assigned can contribute to the efficiency of the device and/or the system.

The static resource pool can be calculated utilizing a leakage-temperature table. The dynamic resource pool can be calculated by subtracting the static resource pool from total resource pool. The leakage-temperature table can associate a temperature, a voltage, and/or a process variation with a leakage current. The leakage-temperature table can also be referred to as a leakage table to reference that the leakage can be dependent on more than the temperature. The leakage current can be subtracted from the total resources of the system to calculate the dynamic resources of the system.

FIG. 1 illustrates an example computing system 100 that includes a memory sub-system 103 in accordance with some embodiments of the present disclosure. The memory sub-system 103 can include media, such as one or more volatile memory devices (e.g., memory device 110), one or more non-volatile memory devices (e.g., memory device 109), or a combination of such.

A memory sub-system 103 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, server, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

In other embodiments, the computing system 100 can be deployed on, or otherwise included in a computing device such as a desktop computer, laptop computer, server, network server, mobile computing device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device. As used herein, the term “mobile computing device” generally refers to a handheld computing device that has a slate or phablet form factor. In general, a slate form factor can include a display screen that is between approximately 3 inches and 5.2 inches (measured diagonally), while a phablet form factor can include a display screen that is between approximately 5.2 inches and 7 inches (measured diagonally). Examples of “mobile computing devices” are not so limited, however, and in some embodiments, a “mobile computing device” can refer to an IoT device, among other types of edge computing devices.

The computing system 100 can include a host system 102 that is coupled to one or more memory sub-systems 103. In some embodiments, the host system 102 is coupled to different types of memory sub-system 103. FIG. 1 illustrates one example of a host system 102 coupled to one memory sub-system 103. As used herein, “coupled to” or “coupled with” generally refers to a connection between components, which can be an indirect communicative connection or direct communicative connection (e.g., without intervening components), whether wired or wireless, including connections such as electrical, optical, magnetic, and the like.

The host system 102 can include a processor chipset and a software stack executed by the processor chipset. The processor chipset can include one or more cores, one or more caches, a memory controller (e.g., an SSD controller), and a storage protocol controller (e.g., PCIe controller, SATA controller). The host system 102 uses the memory sub-system 103, for example, to write data to the memory sub-system 103 and read data from the memory sub-system 103.

The host system 102 includes a processing unit 104. The processing unit 104 can be a central processing unit (CPU) that is configured to execute an operating system. In some embodiments, the processing unit 104 comprises a complex instruction set computer architecture, such an x86 or other architecture suitable for use as a CPU for a host system 102.

The host system 102 can be coupled to the memory sub-system 103 via a physical host interface. Examples of a physical host interface include, but are not limited to, a serial advanced technology attachment (SATA) interface, a peripheral component interconnect express (PCIe) interface, universal serial bus (USB) interface, Fibre Channel, Serial Attached SCSI (SAS), Small Computer System Interface (SCSI), a double data rate (DDR) memory bus, a dual in-line memory module (DIMM) interface (e.g., DIMM socket interface that supports Double Data Rate (DDR)), Open NAND Flash Interface (ONFI), Double Data Rate (DDR), Low Power Double Data Rate (LPDDR), or any other interface. The physical host interface can be used to transmit data between the host system 102 and the memory sub-system 103. The host system 102 can further utilize an NVM Express (NVMe) interface to access components (e.g., memory devices 109) when the memory sub-system 103 is coupled with the host system 102 by the PCIe interface. The physical host interface can provide an interface for passing control, address, data, and other signals between the memory sub-system 103 and the host system 102. FIG. 1 illustrates a memory sub-system 103 as an example. In general, the host system 102 can access multiple memory sub-systems via the same communication connection, multiple separate communication connections, and/or a combination of communication connections.

The memory devices 109, 110 can include any combination of the different types of non-volatile memory devices and/or volatile memory devices. The volatile memory devices (e.g., memory device 110) can be, but are not limited to, random access memory (RAM), such as dynamic random-access memory (DRAM) and synchronous dynamic random access memory (SDRAM).

Some examples of non-volatile memory devices (e.g., memory device 109) include negative-and (NAND) type flash memory and write-in-place memory, such as three-dimensional cross-point (“3D cross-point”) memory device, which is a cross-point array of non-volatile memory cells. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 109, 110 can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLC) can store multiple bits per cell. In some embodiments, each of the memory devices 109 can include one or more arrays of memory cells such as SLCs, MLCs, TLCs, QLCs, or any combination of such. In some embodiments, a particular memory device can include an SLC portion, and an MLC portion, a TLC portion, a QLC portion, or a PLC portion of memory cells. The memory cells of the memory devices 109 can be grouped as pages that can refer to a logical unit of the memory device used to store data. With some types of memory (e.g., NAND), pages can be grouped to form blocks.

Although non-volatile memory components such as three-dimensional cross-point arrays of non-volatile memory cells and NAND type memory (e.g., 2D NAND, 3D NAND) are described, the memory device 109 can be based on any other type of non-volatile memory or storage device, such as such as, read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, and electrically erasable programmable read-only memory (EEPROM).

The memory sub-system controller 105 (or controller 105 for simplicity) can communicate with the memory devices 109 to perform operations such as reading data, writing data, or erasing data at the memory devices 109 and other such operations. The memory sub-system controller 105 can include hardware such as one or more integrated circuits and/or discrete components, a buffer memory, or a combination thereof. The hardware can include digital circuitry with dedicated (i.e., hard-coded) logic to perform the operations described herein. The memory sub-system controller 105 can be a microcontroller, special purpose logic circuitry (e.g., a field programmable gate array (FPGA), an application specific integrated circuit (ASIC), etc.), or other suitable processor.

The memory sub-system controller 105 can include a processor 106 (e.g., a processing device) configured to execute instructions stored in a local memory 107. In the illustrated example, the local memory 107 of the memory sub-system controller 105 includes an embedded memory configured to store instructions for performing various processes, operations, logic flows, and routines that control operation of the memory sub-system 103, including handling communications between the memory sub-system 103 and the host system 102.

In some embodiments, the local memory 107 can include memory registers storing memory pointers, fetched data, etc. The local memory 107 can also include read-only memory (ROM) for storing micro-code. While the example memory sub-system 103 in FIG. 1 has been illustrated as including the memory sub-system controller 105, in another embodiment of the present disclosure, a memory sub-system 103 does not include a memory sub-system controller 105, and can instead rely upon external control (e.g., provided by an external host, or by a processor or controller separate from the memory sub-system).

In general, the memory sub-system controller 105 can receive commands or operations from the host system 102 and can convert the commands or operations into instructions or appropriate commands to achieve the desired access to the memory device 109 and/or the memory device 110. The memory sub-system controller 105 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address, physical media locations, etc.) that are associated with the memory devices 109. The memory sub-system controller 105 can further include host interface circuitry to communicate with the host system 102 via the physical host interface. The host interface circuitry can convert the commands received from the host system into command instructions to access the memory device 109 and/or the memory device 110 as well as convert responses associated with the memory device 109 and/or the memory device 110 into information for the host system 102.

The memory sub-system 103 can also include additional circuitry or components that are not illustrated. In some embodiments, the memory sub-system 103 can include a cache or buffer (e.g., DRAM) and address circuitry (e.g., a row decoder and a column decoder) that can receive an address from the memory sub-system controller 105 and decode the address to access the memory device 109 and/or the memory device 110.

In some embodiments, the memory device 109 includes local media controllers 111 that operate in conjunction with memory sub-system controller 105 to execute operations on one or more memory cells of the memory devices 109. An external controller (e.g., memory sub-system controller 105) can externally manage the memory device 109 (e.g., perform media management operations on the memory device 109). In some embodiments, a memory device 109 is a managed memory device, which is a raw memory device combined with a local controller (e.g., local controller 111) for media management within the same memory device package. An example of a managed memory device is a managed NAND (MNAND) device.

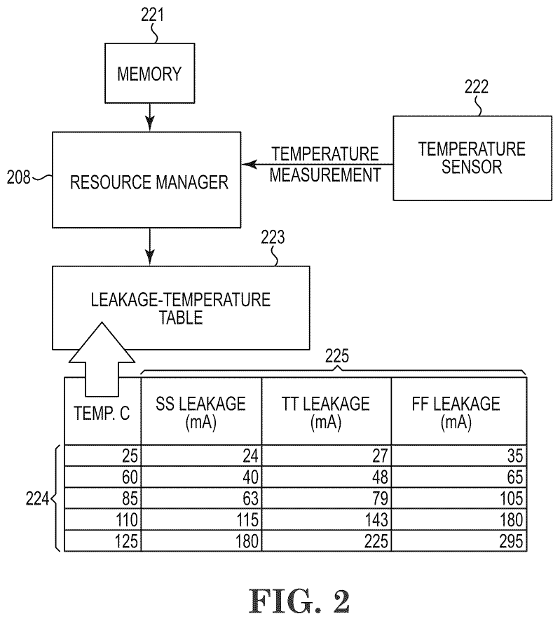

The memory sub-system 103 can include resource manager circuitry 108. Although not shown in FIG. 1 so as to not obfuscate the drawings, the resource manager circuitry 108 can include various circuitry to facilitate aspects of the disclosure described herein in FIG. 2. In some embodiments, the resource manager circuitry 108 can include special purpose circuitry in the form of an ASIC, FPGA, state machine, hardware processing device, and/or other logic circuitry that can allow the resource manager circuitry 108 to orchestrate and/or perform a calculation of a dynamic resource pool and a static resource pool based on a temperature of the memory sub-system 103 and/or devices, particularly with respect to a system-on-chip, in accordance with the disclosure. In various instances, the resource manager circuitry 108 can be external to the memory sub-system controller 105. The memory sub-system controller 105 can determine a temperature of the memory sub-system 103 and can provide the temperature to the external resource manager circuitry 108.

The resource manager circuitry 108 can calculate the dynamic resource pool and static resource pool and can provide power resources and static resources to devices that request them. As used herein, the dynamic resource pool and the static resource pool are a total resource pool of the system. Stated differently, a sum of the dynamic resource pool and the static resource pool are equal to the total resource pool. The total resource pool includes total resources that are available to assign to a device. As detailed herein, a portion (e.g., assigned dynamic resources) of the dynamic resources of the dynamic resource pool and/or a portion (e.g., assigned static resources) of the static resource of the static resource pool can be calculated and assigned to a device to fulfil the request for resources.

For example, the request for resources from the device can be interpreted as a request for dynamic resources (e.g., requested dynamic resources). The resource manager circuitry 108 can assign resources from the dynamic resource pool and/or the static resource pool to fulfill the request for dynamic resources. The resource manager circuitry 108 can calculate the static resources, from the static resource pool, that are needed to assign dynamic resources, from the dynamic resource pool, to the device based on the requested dynamic resources. For instance, the assigned dynamic resources can be equal to the requested dynamic resources. The assigned static resources can be calculated from the assigned dynamic resources. The assigned dynamic resources can be subtracted from the dynamic resource pool while the assigned static resources are subtracted from the static resource pool.

In some embodiments, the memory sub-system controller 105 includes at least a portion of the resource manager circuitry 108. For example, the memory sub-system controller 105 can include a processor 106 (processing device) configured to execute instructions stored in local memory 107 for performing the operations described herein. In some embodiments, the resource manager circuitry 108 is part of the host system 102, an application, or an operating system. The resource manager circuitry 108 can be resident on the memory sub-system 103 and/or the memory sub-system controller 105. As used herein, the term “resident on” refers to something that is physically located on a particular component. For example, the resource manager circuitry 108 being “resident on” the memory sub-system 103 refers to a condition in which the hardware circuitry that comprises the resource manager circuitry 108 is physically located on the memory sub-system 103. The term “resident on” may be used interchangeably with other terms such as “deployed on” or “located on,” herein.

FIG. 2 illustrates an example of resource manager circuitry 208 in accordance with some embodiments of the present disclosure. The resource manager circuitry 208 can be coupled to memory 221, a temperature sensor 222, and a memory (not shown) that stores a leakage-temperature table 223. The memory 221 can be one or more fuses such as an electronic fuse (e-fuse), among other types of memory including one time programmable (OTP) memory, ROM, and/or flash memory. The temperature sensor 222 can include hardware and/or firmware configured to measure a temperature and provide the temperature to the resource manager circuitry 208. Although the temperature sensor 222 is described as a single temperature sensor, the temperature sensor can include multiple sensors. The temperature sensor 222 can be part of the memory sub-system (e.g., the memory-subsystem 103 of FIG. 1), a memory sub-system controller (e.g., the memory sub-system controller 105 of FIG. 1), or the memory devices (e.g., memory devices 109, 110 of FIG. 1). The temperature sensor 222 can also be part of a host system (e.g., the host system 102 of FIG. 1), for example.

The resource manager circuitry 208 can receive the leakage-temperature table 223 which can be stored in a local memory (e.g., the local memory 107 of FIG. 1) and/or memory devices (e.g., the memory devices 109, 110 of FIG. 1), among other locations. In various instances, the memory devices that store the leakage-temperature table 223 can be separate from the local memory and/or the memory devices but may be implemented in the memory sub-system. The memory that stores the leakage-temperature table 223 can also be implemented external to the memory sub-system, such as in a host system (e.g., the host system 102 of FIG. 1).

The leakage-temperature table 223 can include a number of temperatures 224 and associated currents 225. In various instances, the leakage-temperature table 223 can be based on the temperatures 224, voltages, process variations, and/or other factors. The currents can be divided by process variations. As used herein, a process variation can describe a variation of fabrication parameters. The process variations can affect the currents 225 that are leaked at particular temperatures 224. The process variations shown include slow-slow (SS), typical-typical (TT), and fast-fast (FF) process variations that correspond to process corners. However, the process variations shown are exemplary and other process variations can be utilized such as fast-slow and slow-fast, among others.

The leakage-temperature table 223 describes that for the temperature 25° C. the SS current leakage is 24 milliampere (mA), the TT current leakage is 27 mA, and the FF current leakage is 35 mA. The leakage-temperature table 223 describes that for the temperature 60° C. the SS current leakage is 40 mA, the TT current leakage is 48 mA, and the FF current leakage is 65 mA. The leakage-temperature table 223 describes that for the temperature 85° C. the SS current leakage is 63 mA, the TT current leakage is 79 mA, and the FF current leakage is 105 mA. The leakage-temperature table 223 describes that for the temperature 110° C. the SS current leakage is 115 mA, the TT current leakage is 143 mA, and the FF current leakage is 180 mA. The leakage-temperature table 223 describes that for the temperature 125° C. the SS current leakage is 180 mA, the TT current leakage is 225 mA, and the FF current leakage is 295 mA. The leakage-temperature table 223 described is exemplary and other leakage-temperature tables that include different temperatures, currents, and/or process variations can be utilized.

The temperature scale utilized to create the leakage-temperature table 223 can be non-linear to mimic a leakage-temperature dependency. For example, a system can have a temperature step of 5° C. between 110-125° C. junction temperature, a temperature step of 7° C. between 89-110° C. junction temperature, a temperature step of 10° C. between 39-89° C., a temperature step of 14° C. step between 25-39° C., and another step for all temperatures below 25 C.

The information included in the leakage-temperature table 223 can be divided into multiple tables. Although the leakage-temperature table 223 shown includes multiple currents 225 for different process variations, a leakage-temperature table can include a single temperature 224 and multiple currents 225 for different process variations (e.g., a leakage-temperature table for a single temperature). A leakage-temperature table can also include multiple temperatures 224 and currents 225 for a single process variation (e.g., a leakage-temperature table for a process variation). One or more leakage-temperature tables 223 can be provided to the resource manager circuitry 208.

The leakage-temperature table 223 shows that as the temperatures in a memory sub-system, a memory device, and/or a computing system increase, the current leaked becomes non-linear. The non-linear nature of the current leakage can contribute to the inefficient management of the resources of the memory sub-system if the non-linear current leakages are not calculated and taken into account.

The resource manager circuitry 208 can also receive a temperature from the temperature sensor 222 or multiple temperature sensors including the temperature sensor 222. The temperature sensor 222 can measure the temperature of a memory sub-system (e.g., system) or a portion of the memory sub-system. For example, the temperature sensor 222 can measure the temperature of a memory array and/or a bank of memory arrays, among others. The temperature sensor 222 can perform a number of operations on the measured temperature(s) before providing one or more temperatures to the resource manager circuitry 208. For example, the temperature sensor 222 can take a number of measurements of the temperature and can average the temperatures prior to providing a temperature to the resource manager circuitry 208. In various instances, the resource manager circuitry 208 can track historical data from the temperatures provided by the temperature sensor 222 and can predict a future temperature.

The resource manager circuitry 208 can also receive a process variation from the memory 221. The memory (e.g., e-fuse) can be programmed to store a value that corresponds to process variations. A supply current quiescent (IDDQ) test can be utilized to determine leakage values. The IDDQ test can be performed at 110° C., among other possible temperatures for performing the IDDQ test. The leakage values at specific temperatures can be utilized to determine a process variation. For example, at 110° C. a specific leakage can be translated into a process variation that can be TT while a lower leakage at the same temperature can be translated into a process variation which would include SS and a higher leakage can be translated into a process variation which would include FF. Other leakage values measured at the same temperature of 110 C can be translated into corresponding process variations which would lay contiguously between SS and FF. The memory 221 can store a process variation.

The resource manager circuitry 208 can access a process variation from the memory 221. In various instances, the memory 221 can be programmed with the process variation once for the life of the device. The process variation may not change for the life of the device.

Having the temperature received from the temperature sensor 222, the resource manager circuitry 208 can select a current from the leakage-temperature table 223. For instance, the resource manager circuitry 208 can select a temperature 224 utilizing the temperature received from the temperature sensor 222. The resource manager circuitry 208 can select the 125° C. temperature 224. The resource manager circuitry 208 can select a process variation using the process variation provided by the memory 221. The resource manager circuitry 208 can select the FF process variation 225. The resource manager circuitry 208 can utilize the 125° C. temperature 224 and the FF process variation 225 to select a 295 mA current.

Although, the examples described herein utilize the temperatures 224, and process variations 225 to select a current, the process variations can be utilized to select a leakage-temperature table that correlates currents and temperatures. For example, the process variation can be utilized to select a table. Using a temperature and a voltage an anticipated leakage can be selected from the table. Other process tables can be used if a process variation falls between them. For example, a sensor and/or memory 221 can be utilized to determine that the process variation falls between TT and SS. The tables selected using the TT and the SS can be utilized to interpolate the current. For example, a first leakage current can be selected from a first table corresponding to the TT process variation. A second leakage current can be selected from a second table corresponding to the SS process variation. The first leakage current and the second leakage current. can be utilized to generate an expected leakage current.

Other process tables can be of use if the process falls between them. For example, if the sensor/memory-221 indicates that a device process variation lies between TT and SS, both TT and SS tables can be used to interpolate the leakage current.

In various instances, voltages, temperatures 224, and process variations 225 can be utilized to select a leakage-temperature table. For example, there can be several tables for each of the possible voltages of the system. If the possible voltages include 0.8 V, 0.77 V, 0.74V, then each of the voltages can be utilized to select a different table. A leakage-temperature table can be selected based on the actual voltage of the system. A regulator of the system and/or a voltage control circuitry of the system can provide the voltage of a device or a group of devices to the resource manager circuitry 208. The voltage can be utilized to select a leakage-temperature table 223. For instance, the leakage-temperature table 223 can correspond to the 0.8 V of a device.

Alternatively, there can be three tables each associated with one of the process variations 225. Each of the three tables can have voltages and temperatures 224 as entries which can be utilized to access a leakage. The process variation can be utilized to select a table. A voltage and a temperature can be utilized to select a leakage from the selected table. In various examples, each of the temperatures can be associated with a different table. Each of the tables can be used to access a leakage. For instance, a temperature can be utilized to select a table and a voltage and a process variation can be utilized to access a leakage from the selected table.

In various instances, a single table (e.g., leakage-temperature table 223) can be stored. The single table can be 3-dimensional. For instance, a process variation, a voltage, and a temperature can be utilized to select a leakage.

Once the leakage current 225 is selected, the resource manager circuitry 208 can utilize it for the static resource pool, to calculate a dynamic resource pool. The dynamic resource pool can be measured in tokens or a scale that represents power. For example, the dynamic resource pool can be power tokens (e.g., dynamic power tokens). The memory sub-system can have total power tokens available. The static resource pool can be subtracted from the total power tokens (e.g., total resource pool) to generate the dynamic tokens (e.g., dynamic resource pool) available to be assigned to devices requesting resources.

The examples provided herein are given under the assumption that the devices requesting resources are powered (e.g., not gated). If the system contains different power domains, a separate leakage-temperature table can be stored for each of the domains. As used herein, a domain (e.g., power domain) can include gated devices, and/or devices having different voltages, for example. The resource manager circuitry 208 can assign static tokens and dynamic tokens separately for different types of domains. The resource manager circuitry 208 can be aware of the minimum quantity of power tokens it can assign to devices having different power domains. For example, a gated device that is powering on can request a total resource that comprises static and dynamic resources. The resource manager circuitry 208 may not assign less than a particular quantity of static resources to the requesting device. To un-gate the device may utilize some static power tokens. The resource manager circuitry 208 can access a leakage-temperature table based on the voltage of the device, the temperature of the device, the process variation of the device, and whether the device is gated or not (e.g., a power domain of the device).

A device requesting resources can provide a request to the resource manager circuitry 208 for resources. The resource manager circuitry 208 can receive the request for 30 power tokens, for example. The resource manager circuitry 208 can verify that the device can be assigned 30 tokens. Responsive to determining that the device can be assigned 30 tokens, the resource manager circuitry 208 can determine a quantity of tokens (e.g., dynamic resource pool and static resource pool) that can satisfy the 30 power tokens requested. The resource manager circuitry 208 can determine that 35 power tokens, including dynamic resources from the dynamic resource pool and static resources from the static resource pool, can satisfy the request for 30 power tokens (e.g., 30 dynamic power tokens) in view of a leakage. The leakage can be determined to be 5 power tokens. The leakage can be determined using the leakage-temperature table 223.

In examples where the device is a gated device (e.g., power domains), the device can request to un-gate (e.g., power on) and operate. The device can request 30 tokens for dynamic resources and 5 tokens for static resources. The resource manager circuitry 208 can assign less than the 30 dynamic tokens requested but may not assign less than the 5 static tokens requested. The resource manager circuitry 208 can assign between 5 and 35 power tokens.

If the system does not have power domains, the devices of the system are powered and may not be power gated. The system does not have to grant static tokens for every device. It is sufficient to have a combined static pool for devices of the system. If the system reduces the available resources (e.g., total resources) by the total static resources (e.g., combined static pool), the remaining resources take into consideration the 5 static tokens that comprise the leakage of the device. The system does not manage static tokens for the devices if there are no power domains. The system can manage dynamic tokens and not static tokens per device because the static tokens are reserved on the system level. If the devices of the system can be gated, then the system can manage both the static resources and the dynamic resources.

If the device of the system can be gated and if the system does not have sufficient tokens to grant to the devices, the system does not ungate the device until the power tokens can be acquired to ungate the device. The system can decide whether to take some tokens (e.g., dynamic tokens or static tokens) from a different device to allow the device work or allow the device to remain gated. If the devices of the system may not be gated, the system may not gate a device. The leakage of the device takes static resources. The system may be unable to reduce the static resources utilized by the device. The system may adjust dynamic tokens of the remaining power not devoted to static resources.

The leakage current (e.g., static current) can be determined using the leakage-temperature table 223. The leakage current can be converted to power tokens. For example, the leakage current can be converted to power using

$$P = \frac{W}{Δ t} .$$

The wattage (e.g., W) can be calculated using W=Amp*Volt. A voltage of the memory sub-system can be utilized, together with the current, to determine a wattage. The wattage can be utilized with a time for which the resources are assigned to the device to determine a power (e.g., leakage power). The leakage power can be converted to power tokens. The examples provided herein for calculating power tokens is exemplary and is intended to cover multiple ways of calculating power tokens. In various instances, the resource manager circuitry 208 can assign less resources than a device requested. The device may run at a slower speed given that it was assigned less resources than the device requested as compared to a speed the device would have run if it was assigned the resources it requested.

The resource manager circuitry 208 can assign the 35 power tokens which include 30 dynamic power tokens and 5 static power tokens to the device. Calculating the static resources and the dynamic resources used to fulfill the request for resources can allow for a more efficient utilization of resources than assigning fewer dynamic resources than are requested or assigning more dynamic resources than are requested. Calculating the static resources and the dynamic resources can include calculating the static resource pool and the dynamic resource pool. The static resource pool and the dynamic resource pool can be calculated prior to determining whether there are sufficient static resources and dynamic resources for assigning to the device.

The dynamic resource pool, the static resource pool, assigned dynamic resources, and assigned static resources can be calculated at the resource manager circuitry 208. In various instances, the dynamic resource pool and the static resource pool can be calculated at the resource manager circuitry 208 while the requested dynamic resources and the requested static resources are calculated at a device. The assigned dynamic resources and the assigned static resources are not calculated by the device or the resource management circuitry 208. Instead, the resource management circuitry 208 can assign resources to the device without calculating assigned dynamic resources and assigned static resources. For example, the device (e.g., memory device) can receive a temperature (e.g., temperature measurement) from the temperature sensor 222. The temperature sensor 222 can be implemented at the device level or may be implemented external to the device but may provide one or more temperatures to the device as opposed to providing the temperatures to the resource manager circuitry 208.

The device can access the memory 221 to access a process variation. The memory 221 can be implemented at the device level or may be implemented at the memory sub-system level (e.g., system level). The process variation may be unique to the device and/or may be a process variation assigned to the memory sub-system. For example, each of the devices that receive resources from the resource manager circuitry 208 can have process variations assigned to them. For instance, a first device can have an SS process variation while a second device has a TT process variation and a third device has an FF process variation.

The device can access a leakage-temperature table 223. The leakage-temperature table 223 can be unique to the device. For instance, each of the devices that receive resources from the resource manager circuitry 208 can store a different leakage-temperature table. In various instances, the leakage-temperature table can be stored by the device and/or by the resource manager 208. In some examples, each of the devices that receive resources from the resource manager circuitry 208 can access multiple leakage-temperature tables. The devices can select a leakage-temperature table from the multiple leakage-temperature tables based on a voltage of the device. For instance, the device may be subject to voltage variations. The devices can be subject to voltage variations if the devices implement, for example, adaptive voltage and frequency scaling (AVFS) or dynamic voltage and frequency scaling (DVFS), among others. In various instances, the resource manager circuitry 208 can also select a leakage-temperature table 223 from multiple leakage-temperature tables based on a voltage of the memory sub-system and/or a voltage of the device. The memory sub-system can also be subject to voltage variations.

The device can utilize a temperature and a process variation to select a leakage current. The leakage current can be utilized to generate static power tokens. The device may know the target dynamic power tokens (e.g., requested dynamic power tokens) that are utilized to perform a plurality of operations. The device may, utilizing the target dynamic power tokens and the static power tokens, generate a request for power tokens. The device may provide the request for power tokens to the resource manager circuitry 208 indicating that the static power tokens (e.g., static resources) and the dynamic power tokens (e.g., dynamic resources) are included in the request for power tokens. Devices that calculate the static power tokens and/or request dynamic power tokens and static power tokens may be referred to as smart devices.

The resource manager circuitry 208 can receive the request from the device. The resource manager circuitry 208, responsive to receiving the indication from a smart device that the static power tokens are included in the requested power tokens, may refrain from calculating the static power tokens and may instead provide the power tokens that are requested if they are available. Calculating the static power tokens and the dynamic power tokens for requesting resources from the resource manager circuitry 208 can remove computational and/or power demands from the memory sub-system (e.g., resource manager circuitry 208) and can shift the computational and/or power demands to the devices that request resources. The resource manager circuitry 208 can provide the requested power tokens to the device.

In various instances, the resource manager circuitry 208 can, upon receipt of a request for resources, determine whether the device is a smart device or is not a smart device. The resource manager circuitry 208 can make the determination in a number of ways. For example, the request can include an indication that the static power tokens are included in the request for power tokens. In a number of examples, a first command can be utilized to request static power tokens and dynamic power tokens while a second command is utilized to request dynamic power tokens. The first command can be utilized by non-smart devices while the second command is utilized by smart devices. A smart device is not limited to providing the second command but can provide the first command and/or the second command. The non-smart device can provide the first command but may not provide the second command.

Responsive to determining that the device that requested resources is a smart device, the resource manager circuitry 208 can verify that the requested power tokens are available. Responsive to identifying that the requested power tokens are available, the resource manager circuitry 208 can provide the power tokens to the requesting device. Responsive to determining that the requesting device is a non-smart device, the resource manager circuitry 208 accesses the process variation from the memory 221, access a temperature from the temperature sensor 222, and a leakage-temperature table 223. The resource manager circuitry 208 can identify a leakage current corresponding to the process variation and the temperature. The resource manager circuitry 208 can also access a voltage of the requesting device or the memory sub-system. The resource manager circuitry 208 can access the leakage-temperature table 223 utilizing the process variation, the temperature, and/or a voltage.

The resource manager circuitry 208 can determine dynamic power tokens from a dynamic resource pool and static power tokens from a static resource pool. The resource manager circuitry 208 can determine if the dynamic power tokens and the static power tokens are available, from the power tokens (e.g., total resource pool) available to the resource manager circuitry 208, to be distributed. The resource manager circuitry 208 can assign power tokens that include dynamic power tokens and static power tokens to the requesting device.

In a number of examples, the leakage-temperature table 223 can become outdated with time. For example, the leakage current 225 corresponding to a temperature 224 in in the leakage-temperature table 223 may become outdated such that the leakage current 225 is no longer accurate. The leakage-temperature table 223 may be updated to address physical effects of aging among other physical effects such as voltage and/or frequency fluctuations and/or drifts.

By knowing an accurate static (e.g., leakage) current (e.g., current bias) at the temperatures 224 and voltages, the resource manager circuitry 208 can allocate power tokens with greater accuracy than allocating power tokens without calculating static currents. Allocating dynamic power tokens with greater accuracy, as opposed to allocating dynamic power tokens without accurately calculating the static current bias, can improve the overall performance of a system (e.g., memory sub-system).

Although non-limiting examples herein are generally described in terms of applicability to memory sub-systems and/or to memory devices, embodiments are not so limited, and aspects of the present disclosure can be applied as well to a system-on-a-chip, computing system/sub-system, data collection and processing, storage, networking, communication, power, artificial intelligence, control, telemetry, sensing and monitoring, digital entertainment and other types of system/sub-system and/or devices where resources are allocated. Accordingly, aspects of the present disclosure can be applied to these components in order to allocate resources where the allocation of resources includes the calculation of static resource and dynamic resources, as described herein.

The examples described herein are applicable to various types of memory and/or storage devices. For example, power resources can be calculated by a first circuitry and can be provided to a second circuitry utilizing a leakage-temperature table 223 that correlates temperatures to currents. The leakage-temperature table 223 and/or the leakage currents corresponding to temperatures and process variations can be stored in memory, register, arrays, storage devices, and/or files of any type and can be copied to different memory, registers, arrays, storage devices, and/or files of any time.

Although the examples described herein are given in the context of hardware circuitry, dynamic and static resources can be calculated utilizing computer readable instructions. In various instances, the calculation of the dynamic and static resources utilizing a leakage-temperature table 223 can be performed by computer readable instructions which can be utilized to assign resources.

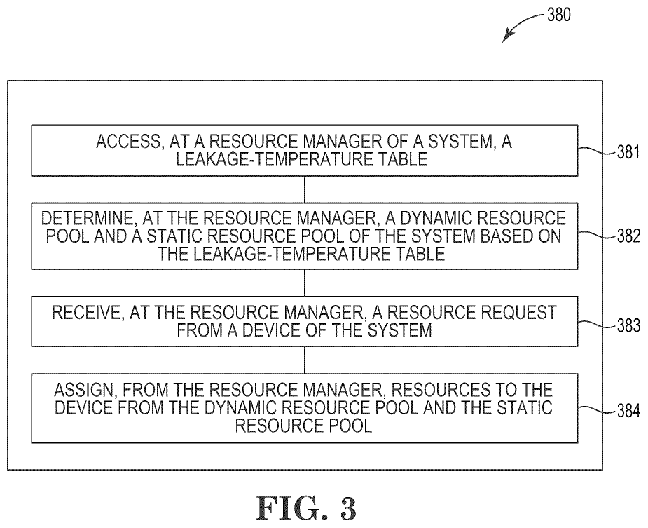

FIG. 3 is a flow diagram corresponding to a method 380 for leakage resource management in accordance with some embodiments of the present disclosure. The method 380 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 380 is performed by the resource manager circuitry 108 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

The method 380 includes managing resources. As described above, resources can be managed utilizing a leakage-temperature table 223 of FIG. 2. At operation 381, a resource manager circuitry 208 of FIG. 2 of a system can access a leakage-temperature table 223 of FIG. 2. The leakage-temperature table 223 of FIG. 2 can associate temperatures with currents such that a current can be selected utilizing a temperature. At operation 382, the resource manager circuitry 208 of FIG. 2 can determine a dynamic resource pool and a static resource pool of the system based on the leakage-temperature table 223 of FIG. 2. The current can be used to determine a static resource pool. The static resource pool can be resources that are unavailable due to leakage. Leakage is a static current that occurs even when a device is not actively operating. Resources that are leaked can include resources that become unavailable for performing operations in the course of performing operations. The static resource pool can be utilized to determine the dynamic resource pool that can be utilized to perform operations. Resources taken by leakage (e.g., static) may not be assigned to a dynamic pool. A static resource pool can be a separate static pool or a total static number calculated from the table and/or devices (e.g., device with the capability to request resources that take into account leakage). The total static resource pool can be deducted from the total resource pool. The remaining resource pool can be assigned to a dynamic resource pool. In various instances, more static resources may be assigned than are consumed by a device. If the temperature and/or voltage of the device and/or the system changes or another smart device is powered after being unpowered, the resource manager circuitry may be unable to reassign the already granted dynamic resources as static resources. By reserving static resources and not allowing them to be assigned as dynamic resources, the resource manager circuitry may prevent dependency on already consumed dynamic resources.

In various instances, the static resources can be reclassified as dynamic resources and/or the dynamic resources can be reclassified as static resources. For instance, as the temperature and/or voltage of the system changes, the static resources can be reclassified as dynamic resources and/or the dynamic resources can be reclassified as static resources.

At operation 383, the resource manager circuitry 208 of FIG. 2 can receive a resource request from a device of the system. The device can be a device that is internal to the system or that is coupled to the system through a bus or a communication channel, for example. The resource request can include a request for power resources expressed as power tokens. At operation 384, the resource manager circuitry 208 of FIG. 2 can assign resources to the device from the dynamic resource pool and the static resource pool. Assigning dynamic resources and static resources allows for the device to fully utilize the assigned dynamic resources while accounting for leakage of power resources.

The resource manager can receive a temperature of the system. The temperature can be received from one or more temperature sensors. The one or more temperature sensors can be part to the system and may be coupled to the resource manager. The one or more temperature sensors can measure a temperature of the system or a portion of the system. The one or more temperature sensors can provide the temperature of the system or the portion of the system to the resource manager. A portion of the system can include a memory device, a memory sub-system, or a component of the memory sub-system, for example. In various instances, the system can be a memory sub-system or a computing system. In various instances, a system can be a network system while a device is a network device. The network device can be coupled to the system utilizing a hardware connection or a wireless connection.

The leakage-temperature table can correlate the temperature to a current that the system leaks. For example, for a given voltage of the system a leakage-temperature table can associate a temperature to a current. The temperature provided by the one or more temperature sensors can be utilized to retrieve a current that leaks.

The dynamic resource pool and the static resource pool can be determined based on the leakage-temperature table and the temperature of the system. For example, the current that is leaked can be used to calculate a static resource pool and the static resource pool can be utilized to calculate the dynamic resource pool. The dynamic resource pool and the static resource pool can be expressed as power tokens. For instance, the dynamic resource pool can be dynamic power tokens and the static resource pool can be static power tokens.

In a number of examples, the static resource pool is a current that is leaked by the system. The leakage current (e.g., static resource) may be unavailable to the device for performing operations or may become unavailable to the device in the course of performing operations. The dynamic resource pool can be expressed as power tokens (e.g., dynamic power tokens) that represent a power that is available to the device for utilization. For instance, the dynamic resource pool represents a power that is available to the device for performing operations (e.g., read/write operations, logical operations, network operations, matrix operations, machine learning operations, etc.). In various instances, the static resource pool can be expressed as static power tokens that represent a power that becomes unavailable to the device for performing operations.

The leakage-temperature table can include one or more temperatures and corresponding currents for each of the one or more temperatures. For example, multiple currents can be associated with a single temperature. The multiple currents can correspond to process variations (e.g., SS, TT, FF, etc.). A first current corresponding to an SS process variation can be associated with a temperature. A second current corresponding to the TT process variation can be associated with the temperature. A third current corresponding to the FF process variation can be associated with the same temperature. A leakage-temperature table can correspond to a voltage of the system and/or the device. For instance, if the device utilizes a first voltage at a first time, a leakage-temperature table that corresponds to the first voltage can be selected. If the device utilizes a second voltage a second time, a leakage-temperature table that corresponds to the second voltage can be selected.

The leakage-temperature table can be selected prior to utilizing a temperature and/or a process variation to select a leakage current. In various instances, the voltage can be provided by the device and/or by one or more sensors of the system. The measurement of the voltage utilized by the system and/or the device can be stored in a memory of the system of the device. The resource manager circuitry can access the voltage measurements from the memory or can receive the voltage measurements. The voltage measurements can be accessed prior to accessing a measured temperature and/or a process variation or after accessing the measured temperature and/or the process variation.

In various instances, each device can be associated with a leakage-temperature table. For example, a leakage-temperature table can be unique to the device. As used herein, a leakage-temperature table can be unique to the device if the device is the only device associated with the leakage-temperature table. In various examples, a device can be associated with multiple leakage-temperature tables. For example, a first leakage-temperature table can be utilized for a device utilizing a first voltage, a second leakage-temperature table can be utilized for the device utilizing a second voltage, and a third leakage-temperature table can be utilized for the device utilizing a third voltage.

In some examples, multiple devices can be associated with a leakage-temperature table. If the leakage-temperature table 223 is stored at the system level and not the device level, the resource manager can associate multiple devices with a leakage-temperature table. Storing the leakage-temperature tables at a central location allows for the leakage-temperature tables to be updated uniformly as opposed to relying on the device to update the leakage-temperature tables.

In various instances, an apparatus can include one or more temperature sensors that measures a temperature of the apparatus. The apparatus can also include a resource manager coupled to the temperature sensor. The one or more temperature sensors can be directly coupled to the apparatus or may be coupled to the apparatus via a bus. The resource manager can receive the temperature from the one or more temperature sensors and can access a leakage-temperature table. For instance, the resource manager can access the leakage-temperature table utilizing the temperature provided by the temperature sensor. The resource manager can determine a dynamic resource pool and a static resource pool of the apparatus based on the leakage-temperature table and the temperature. For example, the resource manager can utilize the temperature to access a current from the leakage-temperature table. The resource manager can utilize the current to calculate a static resource pool. The resource manager can utilize the static resource pool to calculate the dynamic resource pool. The apparatus can assign a resource to the plurality of devices from the dynamic resource pool and the static resource pool.

The resource manager can access a plurality of leakage-temperature tables including the leakage-temperature table. For example, the resource manager can access the leakage-temperature table, from the plurality of leakage-temperature tables, that corresponds to the device. In various instances, the plurality of leakage-temperature tables corresponds to a single device. A leakage-temperature table can be selected for the device from the plurality of leakage-temperature tables based on one or more attributes of the device. For example, a leakage-temperature table can be selected for the device based on a voltage of the device and/or a process variation of the device. A voltage of the device can be utilized to select a leakage-temperature table given that the device may be subject to voltage variations. In some examples, each leakage-temperature table from the plurality of leakage-temperature tables can correspond to a different one of the plurality of devices.

The dynamic resource pool and the static resource pool can be calculated based on a selected device from the plurality of devices. That dynamic resource pool and the static resource pool can be calculated for a device and may be different for a different device. For example, the dynamic resource pool and the static resource pool can be calculated for a device having a first voltage but may be different if calculated for a different device having a second voltage. The resources can be assigned to the selected device from the dynamic resource pool and the static resource pool. For example, dynamic resources can be assigned from the dynamic resource pool and static resources can be assigned from the static resource pool. The dynamic resource and the static resource can comprise the resources assigned to the selected device.

The leakage-temperature table can include a non-linear temperature scale. For example, the steps between a first temperature and a second temperature can have a first distance (e.g., 5° C.) while the steps between the second temperature and the third temperature can have a second distance (e.g., 7° C.). The leakage-temperature table can model a leakage-temperature dependency of the apparatus. As used herein, a leakage-temperature dependency is the relationship between temperatures and current leakage. For example, the current leakage can depend on a temperature. The temperature scale can be based on a leakage-temperature dependency. For instance, as the leakage of current increases with temperature, the distance (e.g., 5° C. vs. 10° C.) between temperatures can decrease.

An e-fuse can provide the process variation to the resource manager. The resource manager can access the leakage-temperature table based on the process variation read from the e-fuse. For instance, a first leakage-temperature table can be accessed if a device has an SS process variation and a second leakage-temperature table can be accessed if the device has a TT process variation.

In various instances, a system can include a device and a resource manager. The device can access a leakage-temperature table. The leakage-temperature table can be stored internal to the device. The device can determine a dynamic resource and a static resource based on the leakage-temperature table. The device can determine a dynamic resource and a static resource in contrast to the resource manager determining the dynamic resource and the static resource. The dynamic resource and the static resource can be determined such that the dynamic resource is equal to or greater than a target resource utilized to perform a plurality of operations. The device can provide a request for the dynamic resource and the static resource to the resource manager.

The resource manager can be coupled to the device. The resource manager can receive the request for the dynamic resource and the static resource. The resource manager can assign a resource to the device based on the request for the dynamic resource and the static resource without determining the static resource.

In a number of examples, the resource manager can assign a resource to the device based on the request for the dynamic resource and the static resource without determining the dynamic resource or the static resource. The resource manager can provide the request without determining the dynamic resource and the static resource.

The device can access a temperature of the device. The device can determine the dynamic resource and the statis resource based on a target dynamic resource, the leakage-temperature table, and the temperature of the device. The target dynamic resource can be a resource utilized to perform operations by the device. The target dynamic resource may not account for leakage.

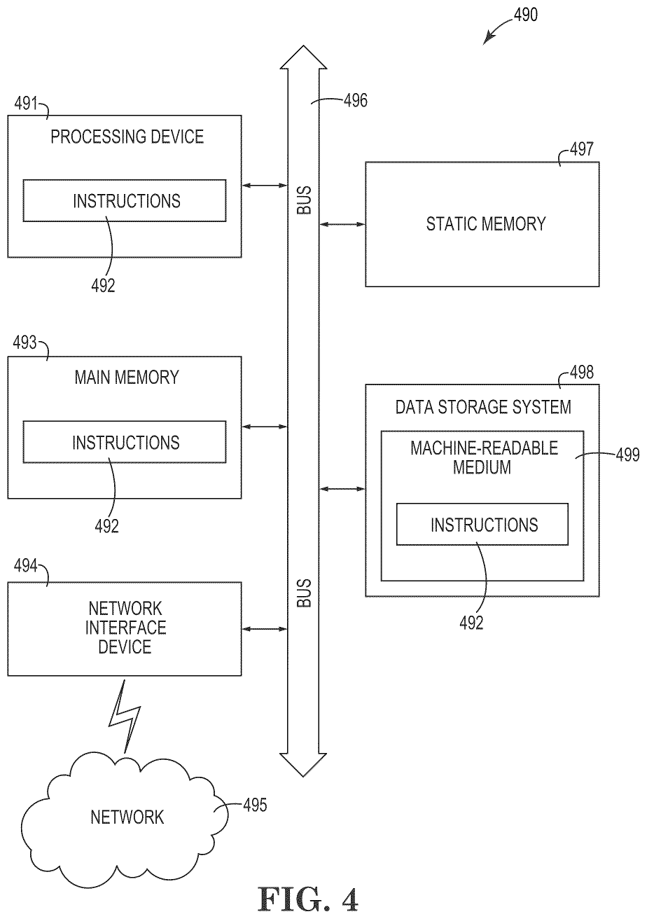

FIG. 4 is a block diagram of an example computer system in which embodiments of the present disclosure may operate. For example, FIG. 4 illustrates an example machine of a computer system 490 within which a set of instructions, for causing the machine to perform any one or more of the methodologies discussed herein, can be executed. In some embodiments, the computer system 490 can correspond to a host system (e.g., the host system 102 of FIG. 1) that includes, is coupled to, or utilizes a memory sub-system (e.g., the memory sub-system 103 of FIG. 1) or can be used to perform the operations of a controller (e.g., to execute an operating system to perform operations corresponding to the resource manager circuitry 108 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 490 includes a processing device 491, a main memory 493 (e.g., read-only memory (ROM), flash memory, dynamic random access memory (DRAM) such as synchronous DRAM (SDRAM) or Rambus DRAM (RDRAM), etc.), a static memory 497 (e.g., flash memory, static random access memory (SRAM), etc.), and a data storage system 498, which communicate with each other via a bus 496.

The processing device 491 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. The processing device 491 can also be one or more special-purpose processing devices such as an application specific integrated circuit (ASIC), a field programmable gate array (FPGA), a digital signal processor (DSP), network processor, or the like. The processing device 491 is configured to execute instructions 492 for performing the operations and steps discussed herein. The computer system 490 can further include a network interface device 494 to communicate over the network 495.

The data storage system 498 can include a machine-readable storage medium 499 (also known as a computer-readable medium) on which is stored one or more sets of instructions 492 or software embodying any one or more of the methodologies or functions described herein. The instructions 492 can also reside, completely or at least partially, within the main memory 493 and/or within the processing device 491 during execution thereof by the computer system 490, the main memory 493 and the processing device 491 also constituting machine-readable storage media. The machine-readable storage medium 499, data storage system 498, and/or main memory 493 can correspond to the memory sub-system 103 of FIG. 1.

In one embodiment, the instructions 492 can include instructions to implement functionality corresponding to resource manager circuitry (e.g., the resource manager circuitry 108 of FIG. 1). While the machine-readable storage medium 499 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method, comprising:
accessing, at a resource manager of a system, a leakage-temperature table;
determining, at the resource manager, a dynamic resource pool and a static resource pool of the system based on the leakage-temperature table;
receiving, at the resource manager, a resource request from a device of the system; and
assigning, from the resource manager, resources to the device from the dynamic resource pool and the static resource pool.

2. The method of claim 1, wherein the dynamic resource pool and the static resource pool comprise a total resource pool of the system.

3. The method of claim 1, further comprising receiving a temperature of the system.

4. The method of claim 3, wherein the leakage-temperature table correlates the temperature to a current that the system leaks.

5. The method of claim 3, wherein the dynamic resource pool and the static resource pool are determined based on the leakage-temperature table and the temperature of the system.

6. The method of claim 1, wherein the static resource pool is at least a current that the system leaks.

7. The method of claim 1, wherein the dynamic resource pool are power tokens that represent a power that is available for operation.

8. The method of claim 1, wherein the leakage-temperature table includes a plurality of temperatures and corresponding currents for each of the plurality of temperatures and wherein the leakage-temperature table is process and voltage dependent.

9. An apparatus comprising:
a temperature sensor configured to measure a temperature of the apparatus; and
a resource manager coupled to the temperature sensor and configured to:
receive the temperature from the temperature sensor;
access a leakage table;
determine a dynamic resource pool and a static resource pool of the apparatus based on the leakage table and the temperature;
assign dynamic resources from the dynamic resource pool and static resources from the static resource pool to a plurality of devices.

10. The apparatus of claim 9, wherein the resource manager is further configured to access a plurality of leakage tables.

11. The apparatus of claim 10, wherein each leakage table from the plurality of leakage tables corresponds to a different one of the plurality of devices.

12. The apparatus of claim 11, wherein each of the plurality of devices is subject to a voltage variation.

13. The apparatus of claim 11, wherein the resource manager is further configured to:
determine the dynamic resource pool and the static resource pool based on a selected device from the plurality of devices; and
assign resources to the selected device from the dynamic resource pool and the static resource pool.

14. The apparatus of claim 9, wherein the leakage table includes a non-linear temperature scale.

15. The apparatus of claim 9, wherein the leakage table models a leakage-temperature dependency of the apparatus.

16. The apparatus of claim 9, further comprising an e-fuse configured to store a process variation.

17. The apparatus of claim 16, wherein the resource manager is further configured to access the leakage table based on the process variation read from the e-fuse.

18. A system comprising:
a device configured to:
access a leakage-temperature table;
determine a dynamic resource and a static resource based on the leakage-temperature table; and
provide a request for the dynamic resource and the static resource; and
a resource manager coupled to the device and configured to:
receive the request for the dynamic resource and the static resource; and
assign a resource to the device based on the request for the dynamic resource and the static resource without determining the static resource.

19. The system of claim 18, wherein the resource manager configured to assign the resource is further configured to assign the resource to the device from a dynamic resource pool and a statice resource pool.

20. The system of claim 18, wherein the device configured to:
access a temperature of the device; and
determine the dynamic resource is further configured to determine the dynamic resource and the static resource based on a target dynamic resource, the leakage-temperature table, and the temperature of the device.
